(19) United States
(12) Patent Application Publication
(10) Pub. No.: US 2021/0265663 A1
(43) Pub. Date: Aug. 26, 2021

(54) NONAQUEOUS ELECTROLYTE SOLUTION FOR MAGNESIUM SECONDARY BATTERY AND MAGNESIUM SECONDARY BATTERY USING THE SAME

(71) Applicant: Panasonic Intellectual Property Management Co., Ltd., Osaka (JP)

(72) Inventors: TOMOFUMI HAMAMURA, Osaka (JP); MITSUHIRO HIBINO, Kyoto (JP); KENSUKE NAKURA, Osaka (JP)

(21) Appl. No.: 17/317,948

(22) Filed: May 12, 2021

Related U.S. Application Data
(63) Continuation of application No. PCT/JP2020/018056, filed on Apr. 28, 2020.

(30) Foreign Application Priority Data
May 22, 2019 (JP) 2019-096316
Apr. 17, 2020 (JP) 2020-073842

(51) Int. Cl. H01M 10/0568; H01M 10/054; H01M 10/0569; C07F 5/04

(52) U.S. Cl. CPC H01M 10/0568; H01M 10/054; H01M 2300/0025; C07F 5/04; H01M 10/0569

(57) ABSTRACT

A nonaqueous electrolyte solution for a magnesium secondary battery contains a nonaqueous solvent; a magnesium salt; and an organoboronate complex salt represented by formula (1) below:

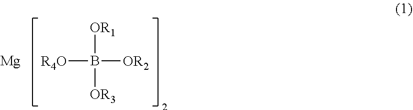

where R₁, R₂, R₃, and R₄ each independently contain a fluoroalkyl group.

### BACKGROUND

### 1. Technical Field

The present disclosure relates to a nonaqueous electrolyte solution for a magnesium secondary battery and a magnesium secondary battery using the electrolyte solution.

### 2. Description of the Related Art

In recent years, the development of a magnesium secondary battery has been awaited.

International Publication No. 2017/170976 describes an electrolytic solution containing a magnesium salt of boronic acid or a magnesium salt of boric acid as well as a Lewis acid or a magnesium sulfonylimide having a specific structure.

J. Mater. Chem. A, 2017, 5, 10815-10820 (Non Patent Literature (NPL) 1) describes a fluorinated alkoxyborate as an electrolyte used for a magnesium secondary battery.

### SUMMARY

In one general aspect, the techniques disclosed here feature a nonaqueous electrolyte solution for a magnesium secondary battery, containing: a nonaqueous solvent; a magnesium salt; and an organoboronate complex salt represented by formula (1) below.

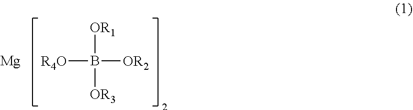

where R₁, R₂, R₃, and R₄ each independently contain a fluoroalkyl group.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view schematically illustrating an exemplary configuration of a magnesium secondary battery;

FIG. 2 is a graph of cyclic voltammograms for Samples 1 and 2;

FIG. 3 is a graph of cyclic voltammograms for Samples 3 and 4; and

FIG. 4 is a graph on which coulombic efficiency is plotted against magnesium salt concentrations in nonaqueous electrolyte solutions.

### DETAILED DESCRIPTION

### Findings Underlying the Present Disclosure

Since two-electron reactions of magnesium are available, expectations are high for a magnesium secondary battery as a high-capacity secondary battery. However, due to strong interaction between divalent magnesium ions and the surrounding solvent, the solvent does not readily dissociate from magnesium ions. In other words, the deposition and dissolution of magnesium metal do not readily occur in a nonaqueous electrolyte solution for a magnesium secondary battery. This is a problem unique to a nonaqueous electrolyte solution for a magnesium secondary battery. In existing magnesium secondary batteries, for example, a nonaqueous electrolyte solution obtained by dissolving a magnesium salt in 1,2-dimethoxyethane or other glymes is used. However, the coulombic efficiency of a magnesium secondary battery using such a nonaqueous electrolyte solution is low. Due to problems like this, severe restrictions are imposed on the combinations of a nonaqueous solvent and a magnesium salt in a magnesium secondary battery.

In view of the findings described above, the present inventors found the following novel nonaqueous electrolyte solution.

### Summary of One Embodiment According to the Present Disclosure

A nonaqueous electrolyte solution for a magnesium secondary battery according to a first aspect of the present disclosure, contains: a nonaqueous solvent; a magnesium salt; and an organoboronate complex salt represented by formula (1) below.

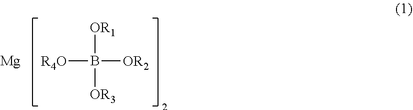

where R₁, R₂, R₃, and R₄ each independently contain a fluoroalkyl group.

According to the first aspect, the organoboronate complex salt can uniformly distribute magnesium ions on the surface of an electrode. Consequently, the deposition and dissolution of metallic magnesium that originates in the magnesium salt are promoted.

In a second aspect of the present disclosure, for example, in the nonaqueous electrolyte solution for a magnesium secondary battery according to the first aspect, the nonaqueous solvent may include an ether solvent. The magnesium salt can be satisfactorily dissolved in an ether solvent.

In a third aspect of the present disclosure, for example, in the nonaqueous electrolyte solution for a magnesium secondary battery according to the second aspect, the ether solvent may coordinate to the organoboronate complex salt. According to the constitution like this, the dissociation of magnesium ions is promoted when an organoboronate complex salt is dissolved in a nonaqueous solvent.

In a fourth aspect of the present disclosure, for example, in the nonaqueous electrolyte solution for a magnesium secondary battery according to the second or the third aspect, the ether solvent may include a glyme.

In a fifth aspect of the present disclosure, for example, in the nonaqueous electrolyte solution for a magnesium secondary battery according to the fourth aspect, the glyme may include at least one selected from the group consisting of 1,2-dimethoxyethane, diglyme, triglyme, and tetraglyme.

According to the fourth and the fifth aspects, it is possible to improve the dissolution properties of a magnesium salt in a nonaqueous electrolyte solution for a magnesium secondary battery.

In a sixth aspect of the present disclosure, for example, in the nonaqueous electrolyte solution for a magnesium secondary battery according to any one of the first to the fifth aspects, R₁, R₂, R₃, and R₄ in formula (1) may be each independently represented by —CₓH_{y}F_{z} and may satisfy 1≤x≤4, 0≤y<9, and 1≤z≤9. According to the constitution like this, it is possible to improve the electrochemical stability of an organoboronate complex salt.

In a seventh aspect of the present disclosure, for example, in the nonaqueous electrolyte solution for a magnesium secondary battery according to any one of the first to the sixth aspects, the magnesium salt may contain, as an anion, at least one selected from the group consisting of [N(FSO₂)₂]⁻, [N(CF₃SO₂)₂]⁻, [N(C₂F₅SO₂)₂]⁻, and [N(FSO₂)(CF₃SO₂)]⁻. These anions can form a salt with magnesium.

In an eighth aspect of the present disclosure, for example, in the nonaqueous electrolyte solution for a magnesium secondary battery according to any one of the first to the seventh aspects, a ratio of a molar concentration of the organoboronate complex salt may be 0.74 or less relative to a sum of a molar concentration of the magnesium salt and the molar concentration of the organoboronate complex salt. According to the constitution like this, it is possible to further promote the deposition and dissolution of metallic magnesium that originates in the magnesium salt.

A magnesium secondary battery according to a ninth aspect of the present disclosure includes a positive electrode; a negative electrode; and the nonaqueous electrolyte solution for a magnesium secondary battery of any one of the first to the eighth aspects.

According to the ninth aspect, for example, by using the nonaqueous electrolyte solution for a magnesium secondary battery of any one of the first to the eighth aspects, the electrochemical stability of the nonaqueous electrolyte solution can be enhanced. Consequently, it is possible to increase the charge-discharge efficiency of the magnesium secondary battery.

Hereinafter, a nonaqueous electrolyte solution for a magnesium secondary battery according to an embodiment and a magnesium secondary battery using the electrolyte solution will be described in detail by means of the drawings.

All the descriptions hereinafter are about general or concrete examples. Accordingly, the numerical values, composition, shapes, thickness, electrical characteristics, the configuration of a secondary battery, and so forth described hereinafter are exemplary and are not intended to limit the present disclosure. Moreover, components that are not recited in the independent claims, which present the broadest concept, are optional components.

### 1. Nonaqueous Electrolyte Solution

The nonaqueous electrolyte solution for a magnesium secondary battery according to an embodiment of the present disclosure, contains: a nonaqueous solvent; a magnesium salt; and an organoboronate complex salt. The organoboronate complex salt has the structure represented by formula (1) below. In formula (1) below, R₁, R₂, R₃, and R₄ each independently contain a fluoroalkyl group. The magnesium salt and the organoboronate complex salt are dissolved in the nonaqueous solvent.

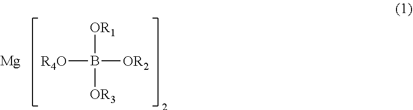

The organoboronate complex salt can uniformly distribute magnesium ions near electrodes. Consequently, the nonaqueous electrolyte solution containing the organoboronate complex salt can promote deposition and dissolution of metallic magnesium. Accordingly, depending on desirable requirements, the efficiency in deposition and dissolution of metallic magnesium can be improved. Such “desirable requirements” may be at least one of, for example, high magnesium ion conductivity, electrochemical stability, chemical stability, thermal stability, safety, low environmental load, and inexpensive price. For example, by dissolving the magnesium salt at a high concentration in the nonaqueous solvent, it is possible to increase the magnesium ion conductivity of the nonaqueous electrolyte solution. For example, by selecting a nonaqueous solvent that is highly resistant to oxidation, it is possible to obtain an electrochemically stable nonaqueous electrolyte solution. For example, by selecting a nonaqueous solvent that is low in toxicity, it is possible to obtain a highly safe nonaqueous electrolyte solution.

The term “organoboronate complex salt” in the present disclosure means a salt of a magnesium ion with a complex ion of an organoboronate complex. In the complex ion of the organoboronate complex, four oxygen atoms bond with a boron atom, and a substituent bonds with each oxygen atom.

The organoboronate complex salt has R₁, R₂, R₃, and R₄ as substituents. R₁, R₂, R₃, and R₄ may be a substituent having the same structure or may be substituents having different structures. Each R₁, R₂, R₃, or R₄ may contain a fluoroalkyl group. The fluoroalkyl group herein means an alkyl group whose at least one hydrogen has been replaced with fluorine. All the hydrogen of the alkyl group may be replaced with fluorine. As the number of fluorine increases, it is possible to further enhance the electrochemical stability of the organoboronate complex salt by the inductive effect. Consequently, the withstand voltage of the nonaqueous electrolyte solution can be increased. The fluoroalkyl group may be linear or branched. In view of dissolution properties in a polar solvent, the carbon number of the fluoroalkyl group may be 1 to 4. The fluoroalkyl group is represented by —CₓH_{y}F_{z}, for example, where x satisfies 1≤x≤4, y satisfies 0≤y<9, and z satisfies 1≤z≤9. Exemplary fluoroalkyl groups include substituents in which at least one hydrogen of a methyl group, an ethyl group, an n-propyl group, an isopropyl group, an n-butyl group, an isobutyl group, a sec-butyl group, and a tert-butyl group has been replaced with fluorine.

The magnesium salt contains an anion. The anion is a monovalent anion, for example.

The magnesium salt contains, as an anion, at least one selected from the group consisting of [N(FSO₂)₂]⁻, [N(CF₃SO₂)₂]⁻, [N(C₂F₅SO₂)₂]⁻, and [N(FSO₂)(CF₃SO₂)]⁻. The anion may be derivatives of these anions. These anions can form a salt with magnesium. The magnesium salt may be a magnesium salt of an imide anion.

The nonaqueous solvent is not particularly limited provided that the magnesium salt can be dissolved. The nonaqueous solvent may include an ether solvent. The magnesium salt can be satisfactorily dissolved in an ether solvent. In view of dissolution properties, the nonaqueous solvent may include a glyme. A glyme can coordinate to a magnesium ion as a bidentate ligand. By using a glyme, it is possible to improve the dissolution properties of the magnesium salt in the nonaqueous solvent. Exemplary glymes include 1,2-dimethoxyethane (DME), diglyme, triglyme, and tetraglyme. In view of oxidation resistance, the nonaqueous solvent may include a fluorinated ether solvent. The fluorinated ether solvent herein means an ether solvent whose at least one hydrogen has been replaced with fluorine.

An ether solvent included in the nonaqueous solvent or another ether solvent may coordinate to the organoboronate complex salt. Specifically, an ether solvent may coordinate to the magnesium ion of the organoboronate complex salt. Due to coordination of an ether solvent to the organoboronate complex salt, the dissociation of magnesium ions is promoted when the organoboronate complex salt is dissolved in the nonaqueous solvent. The ether solvent to be coordinated to the organoboronate complex salt may include a glyme. By using a glyme, it is possible to improve the dissolution properties of the organoboronate complex salt in the nonaqueous solvent. When an organoboronate complex salt is dissolved in a nonaqueous solvent, an ether solvent coordinated to the organoboronate complex salt may be replaced with an ether solvent included in the nonaqueous solvent.

The concentration of the magnesium salt in the nonaqueous electrolyte solution is not particularly limited. By appropriately setting the concentration of the magnesium salt, it is possible to increase magnesium ion conductivity. The concentration of the magnesium salt in the nonaqueous electrolyte solution may be higher than the concentration of the organoboronate complex salt in the nonaqueous electrolyte solution. When the concentration of the magnesium salt is higher than the concentration of the organoboronate complex salt, it is possible to enhance the thermal stability of the nonaqueous electrolyte solution.

A ratio of a molar concentration of the organoboronate complex salt is, for example, 0.74 or less relative to a sum of a molar concentration of the magnesium salt and the molar concentration of the organoboronate complex salt. By appropriately adjusting the concentration of the organoboronate complex salt in the nonaqueous electrolyte solution, it is possible to further promote deposition and dissolution of metallic magnesium that originates in the magnesium salt. The ratio of the molar concentration of the organoboronate complex salt may be 0.70 or less, 0.65 or less, or 0.60 or less relative to the sum of the molar concentration of the magnesium salt and the molar concentration of the organoboronate complex salt. Meanwhile, the lower limit for the ratio of the molar concentration of the organoboronate complex salt may be 0.20, 0.15, or 0.125 relative to the sum of the molar concentration of the magnesium salt and the molar concentration of the organoboronate complex salt.

The nonaqueous electrolyte solution for a magnesium secondary battery according to the present embodiment contains a magnesium salt and an organoboronate complex salt. Consequently, the dissolution current associated with dissolution of metallic magnesium that originates in the magnesium salt, but not in the organoboronate complex salt, is observable. In addition, the dissolution of metallic magnesium that originates in the magnesium salt can be promoted by the organoboronate complex salt. This is due to the following reasons. In some cases, decomposition products or the like of an anion contained in the magnesium salt settle on metallic magnesium that has been deposited through the reduction reaction of the magnesium salt. Such metallic magnesium, on which the decomposition products of the anion contained in the magnesium salt have settled, does not readily undergo dissolution through the oxidation reaction. Here, when the organoboronate complex salt is added as in the present embodiment, the organoboronate complex salt can be uniformly dispersed on an electrode. This suppresses settlement of the decomposition products of the anion contained in the magnesium salt. Consequently, the dissolution of metallic magnesium is promoted through the oxidation reaction.

### 2. Magnesium Secondary Battery

### 2-1. Overall Configuration

The nonaqueous electrolyte solution according to the present embodiment can be utilized for a magnesium secondary battery. Such a magnesium secondary battery includes a positive electrode; a negative electrode; and a magnesium ion-conductive nonaqueous electrolyte solution. For such a nonaqueous electrolyte solution, the nonaqueous electrolyte solution described in [1. Nonaqueous Electrolyte Solution] above can be used appropriately. By using the nonaqueous electrolyte solution of the present disclosure, it is possible to increase the charge-discharge efficiency of a magnesium secondary battery.

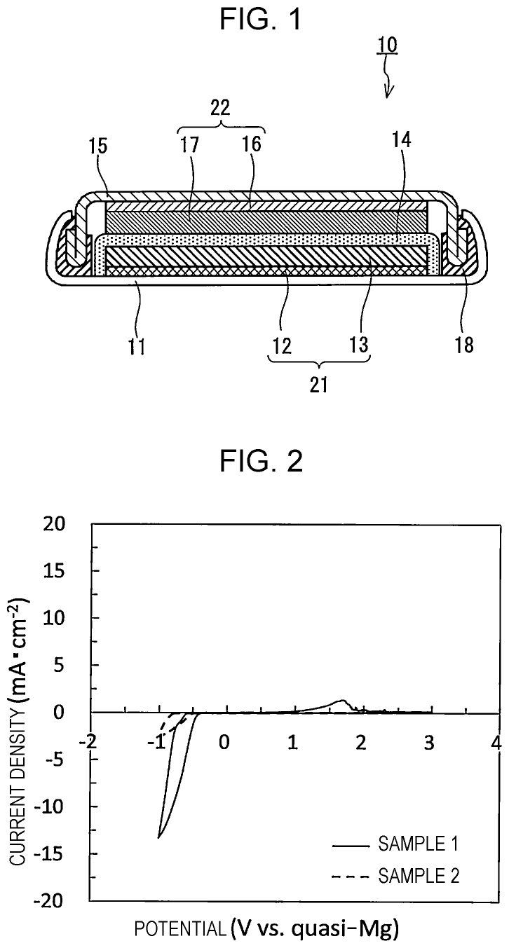

FIG. 1 is a cross-sectional view schematically illustrating an exemplary configuration of a magnesium secondary battery 10.

The magnesium secondary battery 10 includes a positive electrode 21, a negative electrode 22, a separator 14, a case 11, a seal 15, and a gasket 18. The separator 14 is disposed between the positive electrode 21 and the negative electrode 22. The positive electrode 21, the negative electrode 22, and the separator 14 are impregnated with a nonaqueous electrolyte solution and are placed within the case 11. The case 11 is closed with the gasket 18 and the seal 15.

The magnesium secondary battery 10 may have a cylindrical, prismatic, button, coin, or flat structure.

### 2-2. Positive Electrode

The positive electrode 21 includes a positive electrode current collector 12 and a positive electrode active material layer 13 disposed on the positive electrode current collector 12. The positive electrode active material layer 13 is disposed between the positive electrode current collector 12 and the separator 14.

The positive electrode active material layer 13 contains a positive electrode active material. The positive electrode active material may be fluorinated graphite, a metal oxide, or a metal halide. Such a metal oxide and a metal halide may contain magnesium and at least one selected from the group consisting of scandium, titanium, vanadium, chromium, manganese, iron, cobalt, nickel, copper, and zinc. The positive electrode active material may be a sulfide, such as Mo₆S₈, or a chalcogenide, such as Mo₉Se₁₁.

Exemplary positive electrode active materials include MgM₂O₄, MgRO₂, MgXSiO₄, and MgₓZ_{y}AO_{z}F_{w}. Here, M includes at least one selected from the group consisting of Mn, Co, Cr, Ni, and Fe. R includes at least one selected from the group consisting of Mn, Co, Cr, Ni, and Al. X includes at least one selected from the group consisting of Mn, Co, Ni, and Fe. Z includes at least one selected from the group consisting of transition metals, Sn, Sb, and In; and A includes at least one selected from the group consisting of P, Si, and S, where x satisfies 0<x≤2, y satisfies 0.5≤y≤1.5, z is 3 or 4, and w satisfies 0.5≤w≤1.5.

The positive electrode active material layer 13 may further contain a conductive material and/or a binder as necessary.

Exemplary conductive materials include carbon materials, metals, inorganic compounds, and conducting polymers. Exemplary carbon materials include graphite, acetylene black, carbon black, Ketjen black, carbon whiskers, needle coke, and carbon fibers. Examples of graphite include natural graphite and artificial graphite. Examples of natural graphite include vein graphite and flake graphite. Exemplary metals include copper, nickel, aluminum, silver, and gold. Exemplary inorganic compounds include tungsten carbide, titanium carbide, tantalum carbide, molybdenum carbide, titanium boride, and titanium nitride. These materials may be used alone or in mixture.

Exemplary binders include fluorine-containing resins, thermoplastic resins, ethylene-propylene-diene monomer (EPDM) rubber, sulfonated EPDM rubber, and natural butyl rubber (NBR). Exemplary fluorine-containing resins include polytetrafluoroethylene (PTFE), polyvinylidene fluoride (PVdF), and fluoro rubber. Exemplary thermoplastic resins include polypropylene and polyethylene. These materials may be used alone or in mixture.

Exemplary solvents for dispersing a positive electrode active material, a conductive material, and a binder include N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, and tetrahydrofuran. A thickener may be added to a dispersant. Exemplary thickeners include carboxymethyl cellulose and methyl cellulose.

The positive electrode active material layer 13 is formed by the following method, for example. First, a positive electrode active material, a conductive material, and a binder are mixed to obtain a mixture of these materials. Then, an appropriate solvent is added to the resulting mixture to obtain a paste of a positive electrode mixture. Subsequently, the positive electrode mixture is applied to the surface of a positive electrode current collector 12 and dried, thereby forming a positive electrode active material layer 13 on the positive electrode current collector 12. Here, the positive electrode active material layer 13 may be pressed to increase the electrode density.

The thickness of the positive electrode active material layer 13 is not particularly limited and is 1 μm or more and 100 μm or less, for example.

The material for the positive electrode current collector 12 is an elemental metal or an alloy, for example. More specifically, the material for the positive electrode current collector 12 may be an elemental metal or an alloy that contains at least one selected from the group consisting of copper, chromium, nickel, titanium, platinum, gold, aluminum, tungsten, iron, and molybdenum. The material for the positive electrode current collector 12 may be stainless steel.

The positive electrode current collector 12 may be in the form of a plate or a foil. The positive electrode current collector 12 may be a laminated film.

When the case 11 also acts as a positive electrode current collector, the positive electrode current collector 12 may be omitted.

### 2-3. Negative Electrode

The negative electrode 22 includes, for example, a negative electrode current collector 16 and a negative electrode active material layer 17 containing a negative electrode active material. The negative electrode active material layer 17 is disposed between the negative electrode current collector 16 and the separator 14.

The negative electrode active material layer 17 contains a negative electrode active material that enables insertion and extraction of magnesium ions. Exemplary negative electrode active materials include carbon materials. Exemplary carbon materials include graphite, non-graphitic carbon, and graphite intercalation compounds. Examples of non-graphitic carbon include hard carbon and coke.

The negative electrode active material layer 17 may further contain a conductive material and/or a binder as necessary. For such a conductive material, binder, solvent, and thickener, the conductive materials, binders, solvents, and thickeners described in [2-2. Positive Electrode], for example, may be used appropriately.

The thickness of the negative electrode active material layer 17 is not particularly limited and is 1 μm or more and 50 μm or less, for example.

Alternatively, the negative electrode active material layer 17 contains a negative electrode active material that enables deposition and dissolution of magnesium. In this case, exemplary negative electrode active materials include Mg metal and Mg alloys. The Mg alloys are, for example, alloys of magnesium with at least one selected from the group consisting of aluminum, silicon, gallium, zinc, tin, manganese, bismuth, and antimony.

As the material for the negative electrode current collector 16, for example, the same materials for the positive electrode current collector 12 described in [2-2. Positive Electrode] may be used appropriately. The negative electrode current collector 16 may be in the form of a plate or a foil.

When the seal 15 also acts as a negative electrode current collector, the negative electrode current collector 16 may be omitted.

When the negative electrode current collector 16 is formed of a material that enables surface deposition and dissolution of magnesium, the negative electrode active material layer 17 may be omitted. In other words, the negative electrode 22 may be formed solely from the negative electrode current collector 16 that enables deposition and dissolution of magnesium. In this case, the negative electrode current collector 16 may be stainless steel, nickel, copper, or iron.

### 2-4. Separator

Exemplary materials for the separator 14 include microporous membranes, woven fabrics, and nonwoven fabrics. The materials for the separator 14 may be polyolefins, such as polypropylene and polyethylene. The thickness of the separator 14 is 10 μm or more and 300 μm or less, for example. The separator 14 may be a single-layer film formed of one material, a composite film formed from two or more materials, or a multilayer film. The porosity of the separator 14 is 30% or more and 70% or less, for example.

### Examples

### 3. Experimental Results

### 3-1. Preparation of Nonaqueous Electrolyte Solutions

### Sample 1

As a nonaqueous solvent, 1,2-dimethoxyethane (hereinafter, referred to as DME, purchased from Kishida Chemical Co., Ltd.) was used. In 1,2-dimethoxyethane, Mg[N(CF₃SO₂)_{2]2} (hereinafter, referred to as Mg(TFSI)₂, purchased from Kishida Chemical Co., Ltd.), which is a magnesium imide salt, was dissolved at a concentration of 0.35 mol/L. A nonaqueous electrolyte solution of Sample 1 was prepared by further dissolving, in the resulting solution, Mg[B(OCH(CF₃)₂)₄]₂.3DME, which is a 1,2-dimethoxyethane-coordinated organoboronate complex salt, at a concentration of 0.05 mol/L. Here, Mg[B(OCH(CF₃)₂)₄]₂.3DME was prepared by the method described in NPL 1.

### Sample 2

As a nonaqueous solvent, 1,2-dimethoxyethane (purchased from Kishida Chemical Co., Ltd.) was used. A nonaqueous electrolyte solution of Sample 2 was prepared by dissolving Mg(TFSI)₂ (purchased from Kishida Chemical Co., Ltd.) at a concentration of 0.40 mol/L in 1,2-dimethoxyethane.

Both the concentrations of magnesium ions in Sample 1 and Sample 2 were 0.40 mol/L.

### Sample 3

As a nonaqueous solvent, 1,2-dimethoxyethane (purchased from Kishida Chemical Co., Ltd.) was used. In 1,2-dimethoxyethane, Mg(TFSI)₂ (purchased from Kishida Chemical Co., Ltd.) was dissolved at a concentration of 0.85 mol/L. A nonaqueous electrolyte solution of Sample 3 was prepared by further dissolving, in the resulting solution, Mg[B(OCH(CF₃)₂)₄]₂.3DME at a concentration of 0.15 mol/L. Here, Mg[B(OCH(CF₃)₂)₄]₂.3DME was prepared by the method described in NPL 1.

### Sample 4

As a nonaqueous solvent, 1,2-dimethoxyethane (purchased from Kishida Chemical Co., Ltd.) was used. A nonaqueous electrolyte solution of Sample 4 was prepared by dissolving Mg(TFSI)₂ (purchased from Kishida Chemical Co., Ltd.) at a concentration of 1.0 mol/L in 1,2-dimethoxyethane.

Both the concentrations of magnesium ions in Sample 3 and Sample 4 were 1.0 mol/L.

### Sample 5

As a nonaqueous solvent, 1,2-dimethoxyethane (purchased from Kishida Chemical Co., Ltd.) was used. In 1,2-dimethoxyethane, Mg(TFSI)₂ (purchased from Kishida Chemical Co., Ltd.) was dissolved at a concentration of 0.20 mol/L. A nonaqueous electrolyte solution of Sample 5 was prepared by further dissolving, in the resulting solution, Mg[B(OCH(CF₃)₂)₄]₂.3DME at a concentration of 0.80 mol/L. Here, Mg[B(OCH(CF₃)₂)₄]₂.3DME was prepared by the method described in NPL 1.

### Sample 6

As a nonaqueous solvent, 1,2-dimethoxyethane (purchased from Kishida Chemical Co., Ltd.) was used. In 1,2-dimethoxyethane, Mg(TFSI)₂ (purchased from Kishida Chemical Co., Ltd.) was dissolved at a concentration of 0.40 mol/L. A nonaqueous electrolyte solution of Sample 6 was prepared by further dissolving, in the resulting solution, Mg[B(OCH(CF₃)₂)₄]₂.3DME at a concentration of 0.60 mol/L. Here, Mg[B(OCH(CF₃)₂)₄]₂.3DME was prepared by the method described in NPL 1.

### Sample 7

As a nonaqueous solvent, 1,2-dimethoxyethane (purchased from Kishida Chemical Co., Ltd.) was used. In 1,2-dimethoxyethane, Mg(TFSI)₂ (purchased from Kishida Chemical Co., Ltd.) was dissolved at a concentration of 0.60 mol/L. A nonaqueous electrolyte solution of Sample 7 was prepared by further dissolving, in the resulting solution, Mg[B(OCH(CF₃)₂)₄]₂.3DME at a concentration of 0.40 mol/L. Here, Mg[B(OCH(CF₃)₂)₄]₂.3DME was prepared by the method described in NPL 1.

### Sample 8

As a nonaqueous solvent, 1,2-dimethoxyethane (purchased from Kishida Chemical Co., Ltd.) was used. In 1,2-dimethoxyethane, Mg(TFSI)₂ (purchased from Kishida Chemical Co., Ltd.) was dissolved at a concentration of 0.80 mol/L. A nonaqueous electrolyte solution of Sample 8 was prepared by further dissolving, in the resulting solution, Mg[B(OCH(CF₃)₂)₄]₂.3DME at a concentration of 0.20 mol/L. Here, Mg[B(OCH(CF₃)₂)₄]₂.3DME was prepared by the method described in NPL 1.

Here, Samples 1, 3, and 5 to 8 are Examples and Samples 2 and 4 are Comparative Examples.

### 3-2. Evaluation of CV Characteristics

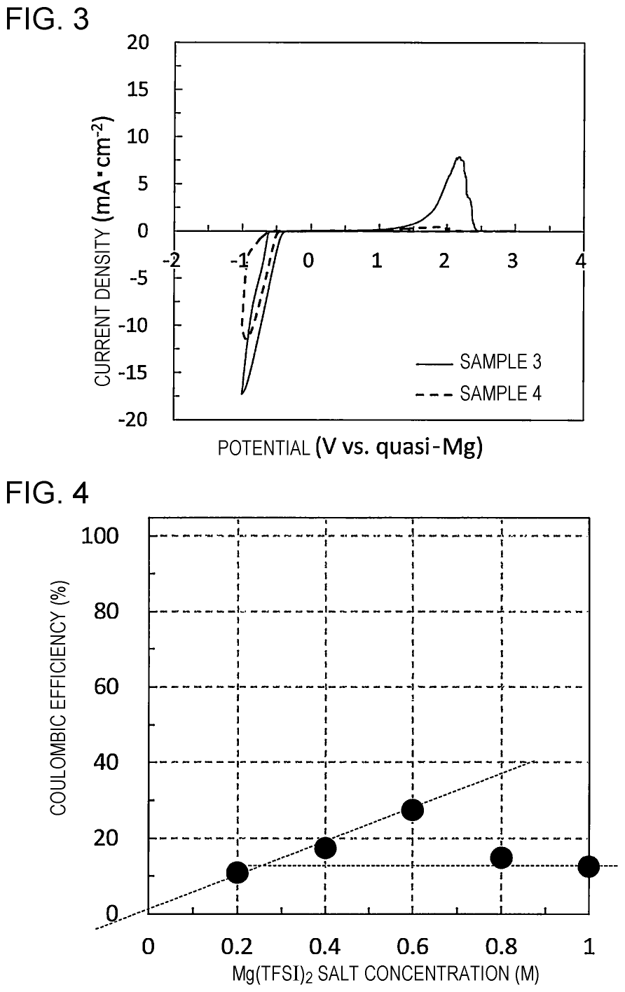

The obtained nonaqueous electrolyte solutions were subjected to cyclic voltammetry (CV) using a beaker cell as a measurement cell and a potentiostat/galvanostat (from BioLogic Sciences Instruments, VSP-300) as a measuring apparatus. A platinum disk electrode was used as a working electrode, and 5 mm×40 mm magnesium ribbons were used as a reference electrode and a counter electrode. Cyclic voltammetry was performed at room temperature (25° C.). The results are shown in FIGS. 2 and 3.

From a cyclic voltammogram, the charge required for deposition of metallic magnesium and the charge required for dissolution of metallic magnesium were calculated. The columbic efficiency was calculated by dividing the charge required for dissolution of metallic magnesium by the charge required for deposition of metallic magnesium.

FIG. 2 is a graph of cyclic voltammograms for Sample 1 and Sample 2. The vertical axis represents the current flowing through the working electrode, and the horizontal axis represents the potential of the working electrode relative to the reference electrode. FIG. 2 shows the results of the tenth cycle when ten cycles of potential scan were repeated in a scan range from −1 V to 3 V. The potential scan rate was 25 mV/s. As shown in FIG. 2, the current presumably due to deposition and dissolution of metallic magnesium was observed for Sample 1. The coulombic efficiency of Sample 1 was 16%, whereas the coulombic efficiency of Sample 2 was 8%. Compared with the coulombic efficiency of Sample 2, the coulombic efficiency of Sample 1 is significantly improved. This is presumably because an organoboronate complex salt contained in the nonaqueous electrolyte solution of Sample 1 promoted deposition and dissolution of metallic magnesium.

From these results, the nonaqueous electrolyte solution of Sample 1 is considered suitable for a magnesium secondary battery.

FIG. 3 is a graph of cyclic voltammograms for Sample 3 and Sample 4. The vertical axis represents the current flowing through the working electrode, and the horizontal axis represents the potential of the working electrode relative to the reference electrode. FIG. 3 shows the results of the tenth cycle when ten cycles of potential scan were repeated in a scan range from −1 V to 3 V. The potential scan rate was 25 mV/s.

The coulombic efficiency of Sample 3 was 46%, whereas the coulombic efficiency of Sample 4 was 8%. Compared with the coulombic efficiency of Sample 4, the coulombic efficiency of Sample 3 is significantly improved. This is presumably because an organoboronate complex salt contained in the nonaqueous electrolyte solution of Sample 3 promoted deposition and dissolution of metallic magnesium.

When an organoboronate complex salt is contained in a nonaqueous electrolyte solution as in the technique described in NPL 1, the current presumably associated with dissolution of metallic magnesium that originates in the organoboronate complex salt is observable in the potential range from 0 V to 1 V. Meanwhile, according to the results of Sample 1 and Sample 3, although an organoboronate complex salt is contained in a nonaqueous electrolyte solution, the current presumably associated with dissolution of metallic magnesium was hardly observed in the potential range from 0 V to 1 V. However, the current densities of Sample 1 and Sample 3 increase in the potential range from 1 V to 2 V compared with the current densities of Sample 2 and Sample 4, respectively. This is understood that the current presumably associated with dissolution of metallic magnesium that originates in the magnesium imide salt increases since an organoboronate complex salt is contained in the nonaqueous electrolyte solutions of Sample 1 and Sample 3.

FIG. 4 is a graph on which coulombic efficiency is plotted against magnesium salt concentrations in the nonaqueous electrolyte solutions of Samples 4 to 8. Here, FIG. 4 plots the coulombic efficiency obtained from the results of the potential scan in the first cycle when Samples 4 to 8 were each subjected to CV in the same manner as FIGS. 2 and 3. The coulombic efficiencies obtained from the result of the potential scan in the first cycle for Samples 4 to 8 were 12.5%, 11%, 17%, 27%, and 15%, respectively. FIG. 4 also shows an approximate straight line obtained from the plot of Samples 5 to 7 and a straight line that passes through Sample 4 and that is parallel to the x-axis. According to the plot of Samples 5 to 7, the coulombic efficiency increases as the concentration of the magnesium imide salt in a nonaqueous electrolyte solution increases. The coulombic efficiency of Sample 8 was lower than the coulombic efficiency of Sample 7. However, the coulombic efficiency of Sample 8 was higher than the coulombic efficiency of Sample 4.

When the concentration of the magnesium imide salt contained in a nonaqueous electrolyte solution is defined as x and the coulombic efficiency as y, the approximate straight line (1) obtained from the plot of Samples 5 to 7 is expressed as y=41.6x+2.0. Meanwhile, the straight line (2) that passes through Sample 4 and that is parallel to the x-axis is expressed as y=12.5. Accordingly, the concentration of the magnesium imide salt at the intersection between the approximate straight line (1) and the straight line (2) was 0.252 mol/L. In other words, it was found in the present embodiment that the coulombic efficiency of a nonaqueous electrolyte solution is higher than the coulombic efficiency of Sample 4 when the concentration of the magnesium imide salt in the nonaqueous electrolyte solution is 0.26 mol/L or more. This reveals that the upper limit of the concentration of an organoboronate complex salt in a nonaqueous electrolyte solution is 0.74 mol/L.

Meanwhile, from FIG. 4, the lower limit of the concentration of an organoboronate complex salt contained in a nonaqueous electrolyte solution is not limited to a specific value. This is because, from FIG. 4, the coulombic efficiency is presumed to increase compared with Sample 4 by incorporating an organoboronate complex salt even in a small amount into a nonaqueous electrolyte solution.

From the results of Sample 1 and Sample 3, it is presumed that an organoboronate complex salt further satisfactorily promotes deposition and dissolution of metallic magnesium by increasing the concentration of magnesium ions contained in a nonaqueous electrolyte solution.

Based on the foregoing results, the nonaqueous electrolyte solution of Sample 3 is considered suitable for a magnesium secondary battery.

The nonaqueous electrolyte solution of the present disclosure can be utilized for magnesium secondary batteries.

What is claimed is:

1. A nonaqueous electrolyte solution for a magnesium secondary battery, comprising:
a nonaqueous solvent;
a magnesium salt; and
an organoboronate complex salt represented by formula (1) below: 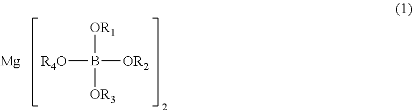
wherein R₁, R₂, R₃, and R₄ each independently contain a fluoroalkyl group.

2. The nonaqueous electrolyte solution for a magnesium secondary battery according to claim 1, wherein
the nonaqueous solvent includes an ether solvent.

3. The nonaqueous electrolyte solution for a magnesium secondary battery according to claim 2, wherein
the ether solvent coordinates to the organoboronate complex salt.

4. The nonaqueous electrolyte solution for a magnesium secondary battery according to claim 2, wherein
the ether solvent includes a glyme.

5. The nonaqueous electrolyte solution for a magnesium secondary battery according to claim 4, wherein
the glyme includes at least one selected from the group consisting of 1,2-dimethoxyethane, diglyme, triglyme, and tetraglyme.

6. The nonaqueous electrolyte solution for a magnesium secondary battery according to claim 1, wherein
R₁, R₂, R₃, and R₄ in formula (1) are each independently represented by —CₓH_{y}F_{z} and satisfy
1≤x≤4, 0≤y<9, and 1≤z≤9.

7. The nonaqueous electrolyte solution for a magnesium secondary battery according to claim 1, wherein
the magnesium salt contains, as an anion, at least one selected from the group consisting of [N(FSO₂)₂]⁻, [N(CF₃SO₂)₂]⁻, [N(C₂F₅SO₂)₂]⁻, and [N(FSO₂)(CF₃SO₂)]⁻.

8. The nonaqueous electrolyte solution for a magnesium secondary battery according to claim 1, wherein
a ratio of a molar concentration of the organoboronate complex salt is 0.74 or less relative to a sum of a molar concentration of the magnesium salt and the molar concentration of the organoboronate complex salt.

9. A magnesium secondary battery comprising:
a positive electrode;
a negative electrode; and
the nonaqueous electrolyte solution for a magnesium secondary battery according to claim 1.
